(19) United States
(12) Patent Application Publication
(10) Pub. No.: US 2004/0100147 A1
(43) Pub. Date: May 27, 2004

(54) Apparatus for inhibiting ring back effect of circuit and method thereof

(75) Inventors: Ming-Chun Chang, ChiaYi (TW); Pao-Lin Chin, HuaLien (TW); Sheng-Kai Chen, ChangHua (TW); Kuo-Lin Tai, ChuPei City (TW)

Correspondence Address: BRUCE H. TROXELL, SUITE 1404, 5205 LEESBURG PIKE, FALLS CHURCH, VA, 22041, US

(73) Assignee: Realtek Semiconductor Corp.

(21) Appl. No.: 10/716,518

(22) Filed: Nov. 20, 2003

(30) Foreign Application Priority Data
Nov. 26, 2002 (TW) 91134246

(51) Int. Cl. H02J 1/10

(52) U.S. Cl. 307/44

(57) ABSTRACT

The apparatus for inhibiting the ring back effect of a circuit comprises a first differential current mode pair and a second differential current mode pair. The first differential current mode pair outputs a first current and a second current through the controlling of a first control signal. The second differential current mode pair outputs a third current and a fourth current through the controlling of a second control signal. The second control signal is the delayed first control signal. The first current and the third current are combined to be the first output current signal, while the second current and the fourth current are combined to be the second output current signal. The magnitude and time delay of the third and fourth currents are designed to compensate the first and second currents respectively so as to inhibit the ring back effect.

### FIELD OF THE INVENTION

This invention relates to an apparatus for inhibiting the ring back effect of a circuit and a method thereof. More particularly, the invention relates to an apparatus for inhibiting the ring back effect of a circuit used in a differential current mode pair and a method thereof.

### DESCRIPTION OF THE PRIOR ARTS

Differential pair amplifiers are commonly used in the circuit design. One popular type of the differential pair amplifiers is the differential current mode pair. The current signal is used as the input of the differential current mode pair.

FIG. 1 shows the front-end processing circuit of a differential current mode pair. In the front-end processing circuit, the differential current 8a and 8b are outputted to a subsequent circuit 9. The front-end processing circuit comprises a current source 10, switches 11a, 11b and switch control signals 13a, 13b. When designing the circuit, the circuit designer has to consider the following issues. The first issue is the rising time of the differential currents 8a and 8b. The rising time is the time interval for the magnitude of a current to change from a level (High/Low) to another (Low/High). The ideal rising time is zero. The practical rising time of the differential currents 8a and 8b should be approached to zero. The second issue is the working point of the circuit. The working point refers to the crossing point of the waveforms of the two differential signals. In order to avoid incorrect operation of the circuit, the ideal working point is at the middle of the two signal levels. The third issue is the ring back effect of the circuit. The ring back effect refers to the ripples of the output currents 8a and 8b. If the ripple is exceeding the tolerate range of the subsequent circuit 9, the subsequent circuit 9 will operate incorrectly.

FIG. 2 shows the ring back effect of a circuit. The output currents 8a and 8b are rippled which is so-called ring back effect. The currents 8a, 8b shown in FIG. 2 have two high peaks, i.e. the overshoot current 21 and the sub-overshoot current 23, and a relative low peak, i.e. the undershoot current 22. In order to avoid the incorrect operation of the subsequent circuit 9, the waveform of the currents has to be smooth. In other words, the ΔI has to be small. In addition, there is another effect called the power bouncing. In the differential pair, the switches 11a and 11b are switched on and off simultaneously. At the transient moment when both the two switches are off, the current cannot flows to the subsequent circuit 9 and accumulates in the circuit. When one of the switches 11a and 11b is turned on, the current accumulated in the circuit flows to the subsequent circuit 9 all at once. Thus, the current flown into the subsequent circuit 9 increased abruptly. This phenomenon is called power bouncing effect. The power bouncing effect can deteriorate the ring back effect of the circuit and seriously degrade the performance of the subsequent circuit 9.

The conventional method to avoid the problems mentioned above is to avoid the simultaneous operation of the two switches. For example, when the switch 11a is about to be switch to “on” and the switch 11b is about to be switched to “off”, the switch 11a is switched to “on” before the switch 11b being switched to “off”. Thus, the two switches will not be switched at the same time and the power bouncing effect can be avoided. However, this conventional method will prolong the rising time and lower the working point.

### SUMMARY OF THE INVENTION

The purpose of this invention is to provide an apparatus for inhibiting the ring back effect of a circuit. In this apparatus, the current is divided into a major current and a minor current, the minor current compensates the major current, and the ring back phenomenon is inhibited.

The second purpose of this invention is to provide a method for inhibiting the ring back effect of a circuit, wherein the output waveform of the circuit is relatively smooth and the total output current of this invention and that of the conventional method are substantially the same.

The method of this invention comprises the steps of: providing a first differential current pair; and providing a second differential current pair, wherein the time delay and the magnitude of the second differential current pair are determined according to the first differential current pair for compensating the ring back effect of the first differential current pair; wherein the second differential pair are coupled to the first differential pair to generate an output current signal pair.

In order to achieve the above purposes, this invention provides an apparatus which comprises: a first differential current mode pair and a second differential current mode pair. The first differential current mode pair outputs a first current and a second current through the controlling of a first control signal. The second differential current mode pair outputs a third current and a fourth current through the controlling of a second control signal. The second control signal is the delayed first control signal. The first current and the third current are combined to be the first output current signal, while the second current and the fourth current are combined to be the second output current signal. The magnitude and time delay of the third and fourth currents are designed to compensate the ripples of the first and second currents respectively so as to inhibit the ring back effect of the circuit.

In a preferred embodiment, the first differential current mode pair is a major current module for outputting a major current to a subsequent circuit. The major current module further comprises: a major source for generating the major current, a major switch coupled to the major source for controlling the output of the major source according to a major controlling signal, and a major controlling signal generator for outputting the major controlling signal. The second differential current mode pair is a compensation current module, coupled to the major current module in parallel, for outputting a compensation current to the subsequent circuit. The compensation current module further comprises: a compensation source for providing the compensation current, a compensation switch coupled to the compensation source for controlling the output of the compensation source according to a compensation controlling signal, and a compensation controlling signal generator for outputting the compensation controlling signal. Wherein a ratio of the major current and the compensation current is determined by a dividing constant.

The various objects and advantages of the present invention will be more readily understood from the following detailed description when read in conjunction with the appended drawings.

### BRIEF DESCRIPTION OF THE DRAWINGS

FIG. 1 shows the conventional circuit of the differential current pair.

FIG. 2 shows the ring back effect of the conventional circuit in FIG. 1.

FIG. 3 is the circuit disclosed in the embodiment of this invention.

FIGS. 4A˜4C show the diagram of output current of the circuit disclosed in the embodiment of the present invention.

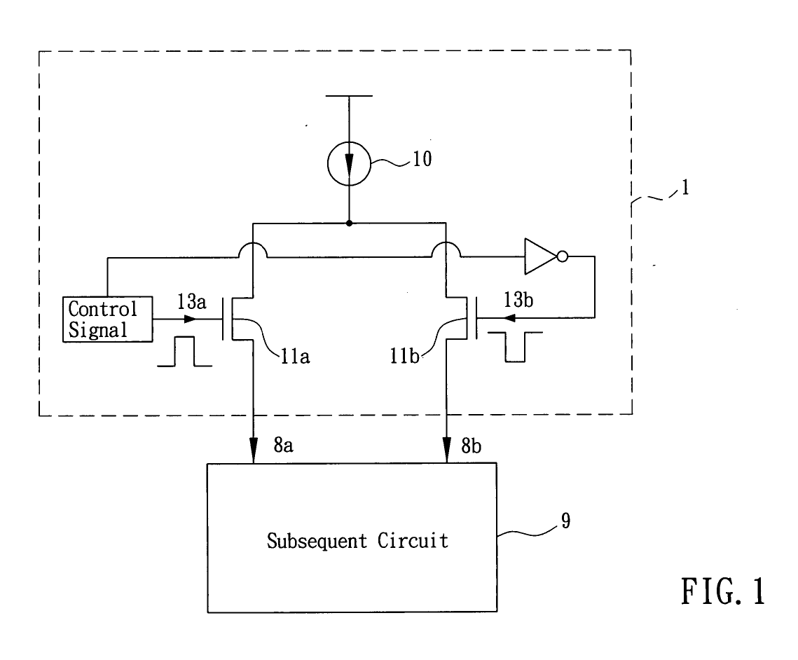

### DETAILED DESCRIPTION OF THE INVENTION

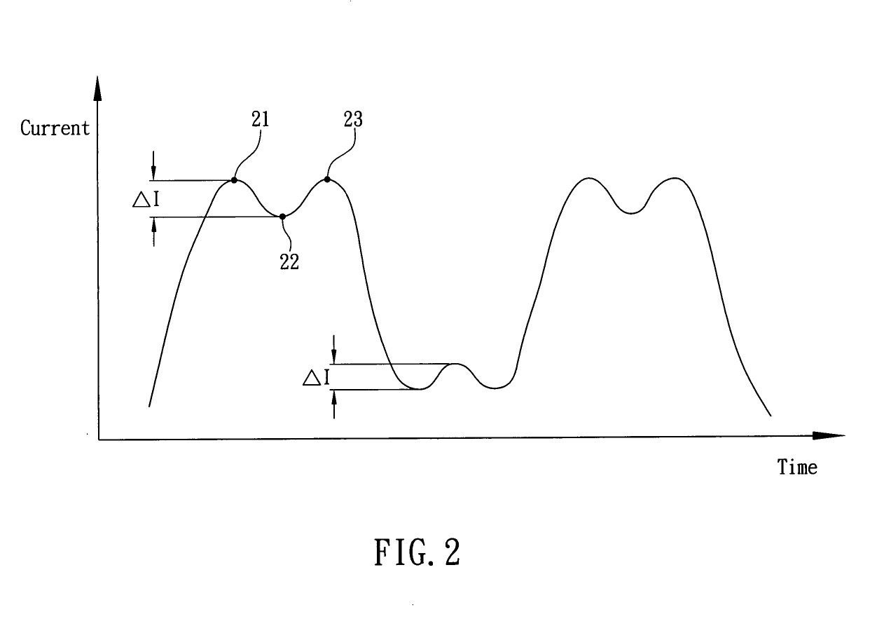

Please refer to FIG. 2, the ripples of the output currents 8a, 8b are the so-called ring back. The effect of ring back is determined by the difference among the overshoot 21, 23, and the undershoot 22. Thus, the ring back effect can be reduced by reducing the differences among the peaks.

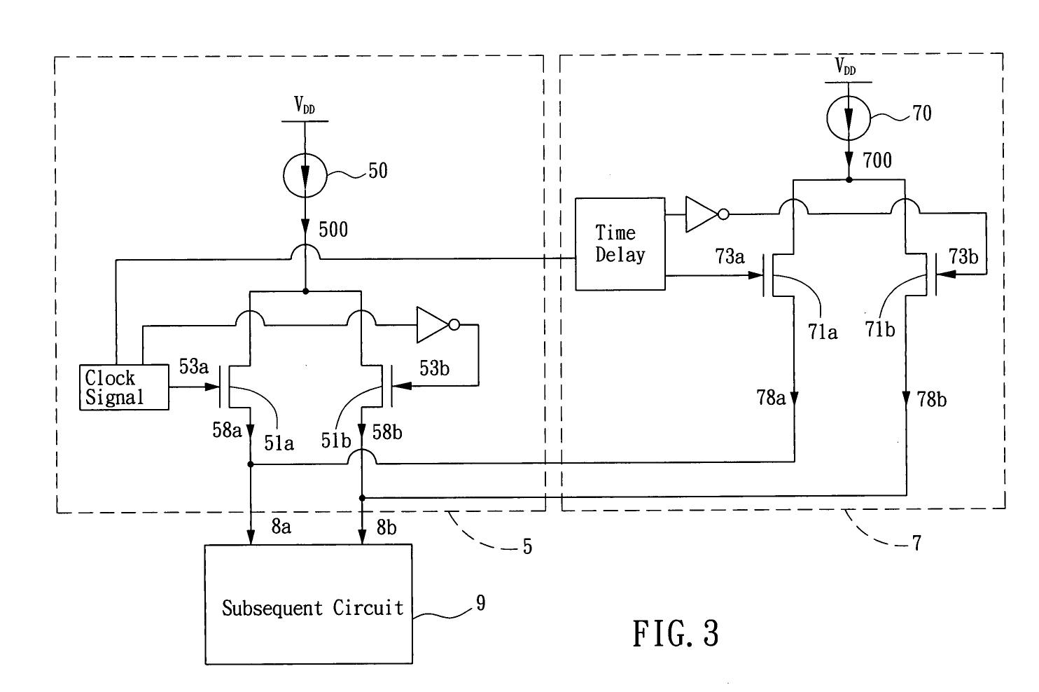

FIG. 3 shows the circuit disclosed in the embodiment of this invention. In the embodiment of this invention, the circuit comprises a major current module 5 and a compensation current module 7. The major current module 5 and the compensation current module 7 are directly outputting to the subsequent circuit 9. The major current module 5 comprises a major current source 50 which generates a major current 500, the switches 51a and 51b coupled to the major current source 50, and the first controlling signals 53a and 53b for controlling major output differential currents 58a and 58b through controlling the “On” and “Off” status of the switches 51a and 51b. The major source 50 can be implemented not only by a current source 50 but also a voltage source with a serial resistance. The major current source 50 can be either an independent source or a dependent source. The structure of the compensation current module 7 is similar to that of the major current module 5. The compensation current module 7 is coupled to the major current module 5 in parallel and outputs the differential currents 78a, 78b to the subsequent circuit 9. The compensation current module 7 comprises a compensation source 70 which generates a compensation current 700, and the compensation switches 71a and 71b coupled to the compensation source 70. The compensation controlling signals 73a and 73b are for controlling the compensation switches 71a and 71b respectively. The compensation source 70 can be either a current source or a voltage source with a serial resistance. The compensation source 70 can be either a dependent source or an independent source. The sum of the major current 500 and the compensation source 700 is substantially equal to the current 10. This can be explained by the following formulas: 8a=58a+78a and 8b=58b+78b.

In this embodiment, a time delay block is coupled between the major current module 5 and the compensation current module 7. Thus, the output current 78a, 78b are delayed. In this manner, the ring back effect of the output current 8a, 8b can be compensated by the output current 78a, 78b respectively due to the delay of the output current 78a, 78b. Because the structures of the circuit module 5 and the circuit module 7 are similar, the rising times of these two circuit modules are substantially the same. The output current 78a, 78b are outputted when the major current approximately reaches the overshoot status 21. Because the compensation current 700 is smaller than the major current 500, the ripple of the compensation current 700 is smaller than that of the major current 500. When the amplitude of the major current 500 begins to drop, the compensation current 700 begins to rise which smoothes the waveform of the major current 500. When the compensation current 700 is at the overshoot status 21, the compensation current 700 can compensate the undershoot status 22 of the major current 500. When the compensation current 700 is at the undershoot status 22, the major current 500 is at the sub-overshoot status 23 which also smoothes the waveform of the major current 500. Thus, the sum of the major output current 58a and the compensation output current 78a could be substantially maintained. As a result, the output waveform is smooth and the ring back is inhibited.

The ratio of the major current and the compensation current is important to optimize the compensation effect. If the amount of the output currents 8a and 8b is 1, the amount of the compensation current 700 is 1/A and the amount of the major current 500 is (A−1)/A. Base on the result of the simulation, the value of A is within the range of 15 to 20. In other words, the range of the compensation current 700 is about 5% to 6.7% of that of the major current 500.

The delay time for outputting the compensation current 700 is also important for the compensation. If the delay time of the compensation current 700 is not appropriate, the ring back effect may be worsened. The delay time is related to the arrangement of the circuit elements. The appropriate delay time of the compensation current 700 is when the major current is approximately at the overshoot status 21. Base on the experimental result, the optimal delay time is 0.8 ns in the embodiment of this invention.

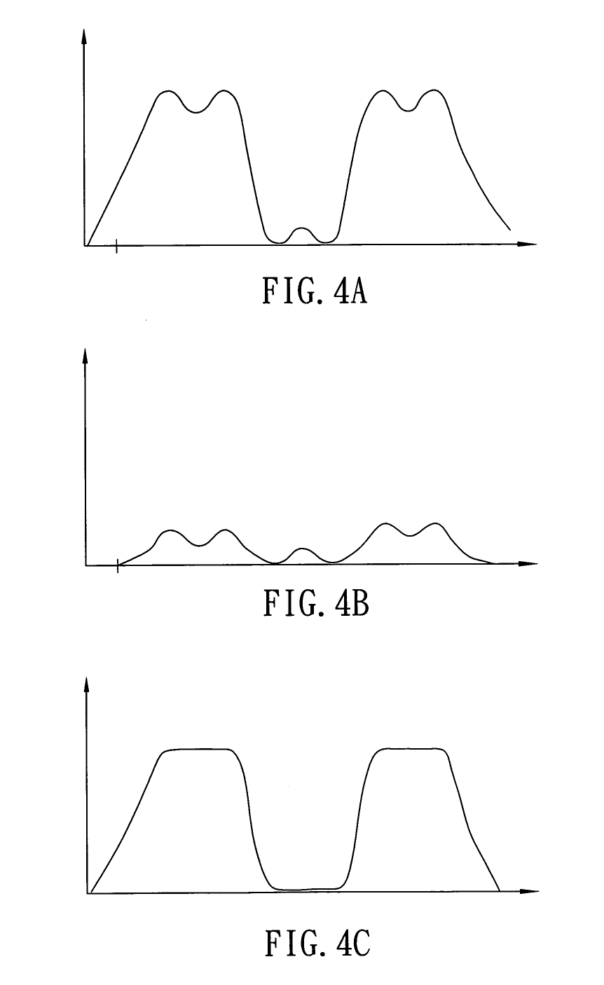

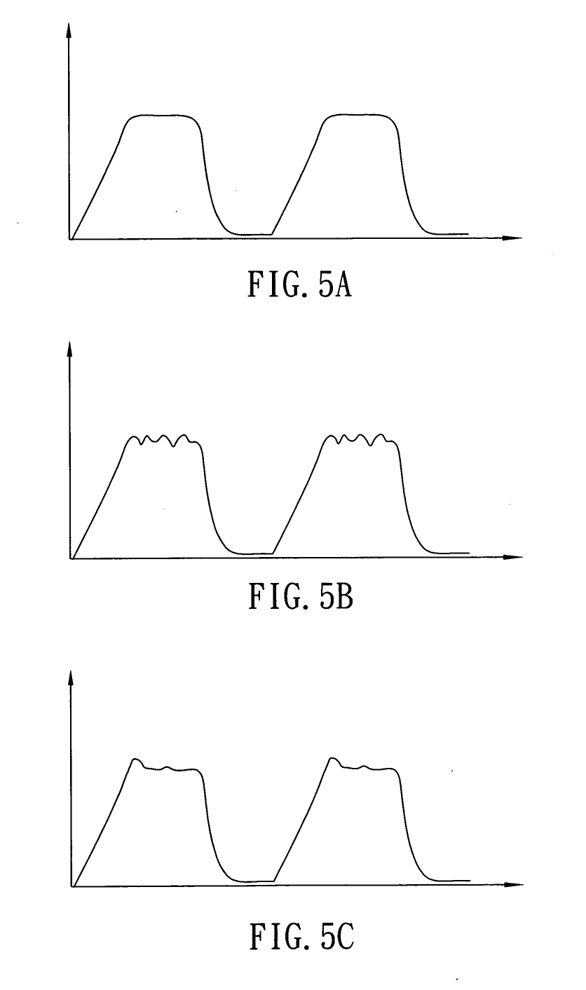

FIGS. 4A, 4B, and 4C show the output current signal of the embodiment. The X-axis represents time. FIG. 4A shows the waveform of the major output current 58a. FIG. 4B shows the waveform of the compensation current 78a. FIG. 4C shows the combined current 8a. In comparing with the waveform of the conventional circuit in FIG. 2, the waveform in FIG. 4C is more smoothed and ring back effect is improved. Thus, the performance of the subsequent circuit 9 can be improved.

While the present invention has been shown and described with reference to preferred embodiments thereof, and in terms of the illustrative drawings, it should be not considered as limited thereby. Various possible modification, omission, and alterations could be conceived of by one skilled in the art to the form and the content of any particular embodiment, without departing from the scope and the spirit of the present invention.

What is claimed is:

1. An apparatus for inhibiting a ring back effect of a circuit, comprising:
a first differential current mode pair for outputting a first current and a second current through the controlling of a first control signal; and
a second differential current mode pair for outputting a third current and a fourth current through the controlling of a second control signal, wherein the second control signal is the delayed first control signal;
wherein a first output current signal is corresponding to the first current and the third current and a second output current signal is corresponding to the second current and the fourth current.

2. The apparatus of claim 1, wherein the first differential current mode pair includes:
a first source for generating a first current, and
a first switch, coupled to the first source, for outputting the first current according to a first control signal; and
a second switch, coupled to the first source, for outputting the second current according to the inverted first control signal; and
the second differential current mode pair includes:
a second source for generating a second current;
a third switch, coupled to the second source, for outputting the third current according to a second control signal; and
a fourth switch, coupled to the second source, for outputting the fourth current according to the inverted second control signal.

3. The apparatus of claim 2, wherein the output of the second source is smaller than the output of the first source.

4. The apparatus of claim 3, wherein the ratio of the output of the second source and the output of the first source is a constant.

5. The apparatus of claim 1, wherein further includes a time delay unit for providing the second control signal through delaying the first control signal.

6. The apparatus of claim 1, wherein at least one of the first source and the second source is a current source.

7. The apparatus of claim 1, wherein at least one of the first source and the second source is a voltage source.

8. The apparatus of claim 1, wherein at least one of the first source and the second source is an independent source.

9. The apparatus of claim 1, wherein at least one of the first source and the second source is a dependent source.

10. A method for inhibiting a ring back effect of the circuit, comprising:
providing a first differential current pair; and
providing a second differential current pair, wherein the time delay and the magnitude of the second differential current pair are determined according to the first differential current pair for compensating the ring back effect of the first differential current pair;
wherein the second differential pair are coupled to the first differential pair to generate an output current signal pair.

11. The method of claim 10, wherein time delay of the first and the second differential current pair is adjustable.

12. The method of claim 10, wherein the ratio of the first differential current pair and the second differential current pair is a constant.
